(19) United States
(12) Patent Application Publication
(10) Pub. No.: US 2004/0061796 A1
(43) Pub. Date: Apr. 1, 2004

(54) Image capturing apparatus

(75) Inventors: Tsutomu Honda, Sakai-Shi (JP); Toshihisa Maeda, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/326,301

(22) Filed: Dec. 19, 2002

(30) Foreign Application Priority Data
Sep. 30, 2002 (JP) P2002-286046

(51) Int. Cl. H04N 5/335

(52) U.S. Cl. 348/297

(57) ABSTRACT

The present invention provides an image capturing apparatus capable of dealing with a blurring which generates at the time of image capturing even with exposure in short time without increasing the size of the apparatus. In a CCD, charge signals accumulated in a light receiving part can be sequentially read from first to third fields of a pixel array of the light receiving part. In an image capturing operation, charge signals accumulated in each of two periods obtained by dividing the exposure time into halves are read as first and second divided image data from the first field. By comparing the read two pieces of image data by an image comparator, an amount of a relative blurring between the subject and an image capturing apparatus is detected.

This application is based on application No. 2002-286046 filed in Japan, the contents of which are hereby incorporated by reference.

### BACKGROUND OF THE INVENTION

1. Field of the Invention

The present invention relates to an image capturing apparatus, and more particularly to a technique of performing an appropriate operation against blurring in an image which is caused by movement of camera or the like.

2. Description of the Background Art

At the time of capturing an image by an image capturing apparatus, it is widely known that a blurring occurs between a subject and a captured image due to motion of a subject, movement of camera or the like. Since the “blurring” in the captured image corresponds to a state where the image is out of focus, it is also expressed as a “defocus”. In the specification, such a state will be referred to as a “blurring”. Although there is a case that the blurring of a captured image is positively applied as a photo-taking technique such as panning, the blurring is generally regarded as deterioration in picture quality.

General methods for preventing such a “blurring” in a captured image include a method of fixing an image capturing apparatus by a tripod or the like so as not to be moved and a method of mounting a gyro or the like to detect a movement of camera or the like and correcting a captured image. However, at an actual site of capturing an image, in many cases, there is no time to set a tripod. Further, by adding a tripod, gyro or the like, increase in the size of the image capturing apparatus is caused.

As a countermeasure against such a problem, there is provided a method of correcting a blurring in a captured image by capturing a plurality of images with a plurality of successive exposures at the time of performing an exposure for long time, compensating relative motions of the subject in the plurality of images, and adding the plurality of images (for example, Patent Literature 1). According to the method, a special device such as a tripod or gyro is unnecessary, and a blurring of a captured image can be corrected without increasing the size of the image capturing apparatus.

Literature of a prior art of such a technique is as follows.

Patent Literature 1

Japanese Patent Application Laid-Open No. 2001-86398

In the method disclosed in Patent Literature 1, however, exposure of long time is divided into a plurality of successive exposures. Consequently, in the case where the user wishes to set shutter speed to be high, the method cannot be applied. For example, in the case where the position of a subject or situation largely changes, the shutter speed should be set to be high.

### SUMMARY OF THE INVENTION

The present invention is directed to an image capturing apparatus.

In accordance with one aspect of the present invention, the image capturing apparatus includes: an image sensor capable of sequentially reading, as image data, charge signals accumulated in a light receiving part from each of a plurality of fields of the light receiving part; a setting unit for setting exposure time of the image sensor; a divider for dividing the exposure time which is set by the setting unit into a plurality of periods; a reader for reading the charge signals accumulated in the light receiving part as first and second image data from a first field in the plurality of fields in each of two periods out of the plurality of periods; a comparator for comparing the first and second image data read by the reader; and a controller for controlling an operation of the image capturing apparatus in accordance with a result of the comparison by the comparator.

By using an image sensor capable of sequentially reading charge signals accumulated in a light receiving part from each of a plurality of fields of the pixel array of the light receiving part, at the time of image capturing, reading charge signals accumulated in two or more periods out of a plurality of periods obtained by dividing exposure time as image data, and comparing the image data, it is possible to provide an image capturing apparatus capable of dealing with a blurring which occurs at the time of the image capturing even in exposure of short time without increasing the size of the apparatus.

In accordance with one preferable aspect of the present invention, the image capturing apparatus further includes a detector for detecting a state of a blurring which occurs between a subject and the image capturing apparatus in accordance with the result of comparison by the comparator.

Since the states of the blurring such as the amount of the blurring and the direction of the blurring which occurs between the subject and the image capturing apparatus is detected, a blurring which occurs at the time of image capturing can be coped with.

In accordance with another preferable aspect of the present invention, the detector detects an amount of the blurring which occurs between the subject and the image capturing apparatus, and the controller gives a warning when the amount of the blurring which is equal to or larger than a predetermined amount is detected by the detector.

When the amount of a blurring which occurs between the subject and the image capturing apparatus is large to some extent, a warning is given. Consequently, the user can be notified with reliability of the situation such that a blurring may occur in a captured image, so that the notification can contribute determination after that of the user.

In accordance with still another preferable aspect of the present invention, the image capturing apparatus further includes an image processor for processing image data read by the image sensor, and the controller changes an image process performed by the image processor in accordance with the state of the blurring detected by the detector.

Since the contents of the image process are changed in accordance with the states of the blurring such as the amount of the blurring and the direction of the blurring detected, an appropriate image according to the states of the blurring can be generated.

In accordance with yet another preferable aspect of the present invention, when the exposure time set by the setting unit is longer than predetermined time, the divider divides the exposure time set by the setting unit into the plurality of periods.

Since the blurring amount is detected in the case where the possibility of occurrence of a blurring between the subject and the image capturing apparatus is high, a useless process is omitted in the case where the possibility of occurrence of a blurring is extremely low. Thus, the image capturing process can be performed promptly and power consumption can be reduced.

In accordance with yet another preferable aspect of the present invention, the image capturing apparatus further includes an electronic flash device for illuminating a subject with flashlight. At the time of image capturing with flashlight emitted by the flash device, the divider does not divide the exposure time set by the setting unit into a plurality of periods.

When the possibility of occurrence of a blurring is extremely low, by omitting a useless process, the image capturing process can be performed promptly while power consumption can be reduced. If the exposure time is divided into a plurality of periods at the time of image capturing with flashlight, flashlight is emitted only in a part of the plurality of periods of the exposure time, a large difference occurs in the image data to be compared with each other, the image data cannot be consequently compared accurately, and erroneous operation is caused. In the aspect of the present invention, the erroneous operation can be prevented.

Therefore, an object of the present invention is to provide an image capturing apparatus which can deal with a blurring which occurs at the time of capturing an image even with exposure of short time without increasing the size of the apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing the appearance of an image capturing apparatus according to an embodiment of the present invention;

FIG. 2 is a rear view schematically showing the appearance of the image capturing apparatus according to the embodiment of the present invention;

FIG. 3 is a block diagram showing the functional configuration of the image capturing apparatus;

FIG. 4 is a diagram for describing the flow of an image signal and the like in the image capturing apparatus;

FIGS. 5A to 5C are diagrams for describing a method of reading charges in a CCD;

FIG. 6 is a diagram for describing a high-speed reading mode of the CCD;

FIGS. 7A and 7B are diagrams illustrating the positional relation of specific points;

FIGS. 8A and 8B are diagrams illustrating the positional relation of specific points;

FIGS. 9A and 9B are diagrams illustrating the positional relation of specific points;

FIG. 10 is a diagram illustrating indication of a blurring occurrence warning;

FIG. 11 is a flowchart for describing an image capturing operation of the image capturing apparatus;

FIG. 12 is a flowchart for describing the image capturing operation of the image capturing apparatus;

FIG. 13 is a flowchart for describing the image capturing operation of the image capturing apparatus;

FIG. 14 is a diagram for describing the image capturing operation of the image capturing apparatus; and

FIGS. 15A and 15B are diagrams for describing a charge reading method according to a modification.

### DESCRIPTION OF THE PREFERRED EMBODIMENTS

Hereinafter, embodiments of the present invention will be described with reference to the drawings.

(1) Outline of Image Capturing Apparatus

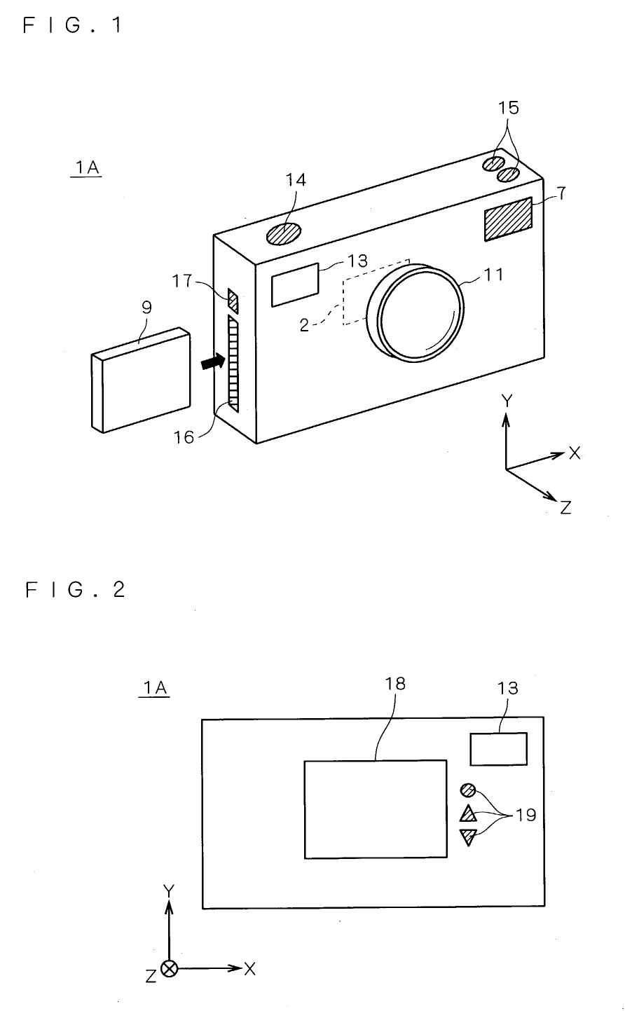

FIG. 1 is a perspective view showing an image capturing apparatus 1A according to a first embodiment of the present invention. FIG. 2 is a rear view of the image capturing apparatus 1A. In each of FIGS. 1 and 2, three axes of X, Y and Z which perpendicularly cross each other are shown to clarify the directional relations.

On the front face side of the image capturing apparatus 1A, a taking lens 11, a viewfinder window 13, and a built-in electronic flash 7 as a light emitting part for illuminating the subject with light are provided. The image capturing apparatus 1A has therein a CCD (Charge Coupled Device) 2. The CCD 2 photoelectrically converts an image of the subject entering via the taking lens 11 into an image signal.

The taking lens 11 includes a lens unit which can be driven along the optical axis direction. By driving the lens unit in the optical axis direction, a focus state of the subject image formed on the CCD 2 can be achieved.

On the top face side of the image capturing apparatus 1A, a shutter start button 14 and mode switching buttons 15 are disposed. The shutter start button 14 is a button for giving an instruction of capturing an image to the image capturing apparatus 1A when depressed by the user at the time of capturing an image of a subject. In this case, when the shutter start button 14 is touched (state SI), an auto-focus operation (AF operation) which will be described later is performed. When the shutter start button 14 is fully depressed (state S2), an image capturing operation which will be described later is performed.

The mode switching buttons 15 are buttons for switching modes such as an “image capturing” for capturing an image of a subject and a “reproduction mode” for reproducing the captured image and displaying the reproduced image onto a liquid crystal display (LCD) 18. When the image capturing apparatus 1A is switched to the image capturing mode in a state where the power is ON, the image capturing apparatus 1A enters an image capturing standby state in which the image capturing apparatus 1A can capture an image.

On a side face of the image capturing apparatus 1A, a slot 16 into which a memory card 9 is inserted and a card ejection button 17 are provided. In the memory card 9 which is inserted into the slot 16, image data captured by the image capturing operation is stored. By depressing the card ejection button 17, the memory card 9 can be ejected from the slot 16.

On the rear face of the image capturing apparatus 1A, the liquid crystal display (LCD) 18, operation buttons 19 and the viewfinder window 13 are provided. The liquid crystal display (LCD) 18 performs live view display for displaying an image of a subject in a moving image manner before the image capturing operation and displays a captured image and the like. The operation buttons 19 are buttons for changing various setting states of the image capturing apparatus 1A such as the use/unuse of the built-in electronic flash 7 and shutter speed. When the user variously operates the operation buttons 19, a “blurring correcting mode” for correcting “a blurring in a captured image” which will be described later can be set. Further, when the “blurring correcting mode” is set, the operation buttons 19 function as buttons for erasing image data stored in a memory 43a provided in an image processing unit 43 which will be described later. The image capturing operation in the blurring correcting mode as a characteristic portion of the present invention will be described in detail later.

(2) Internal Configuration

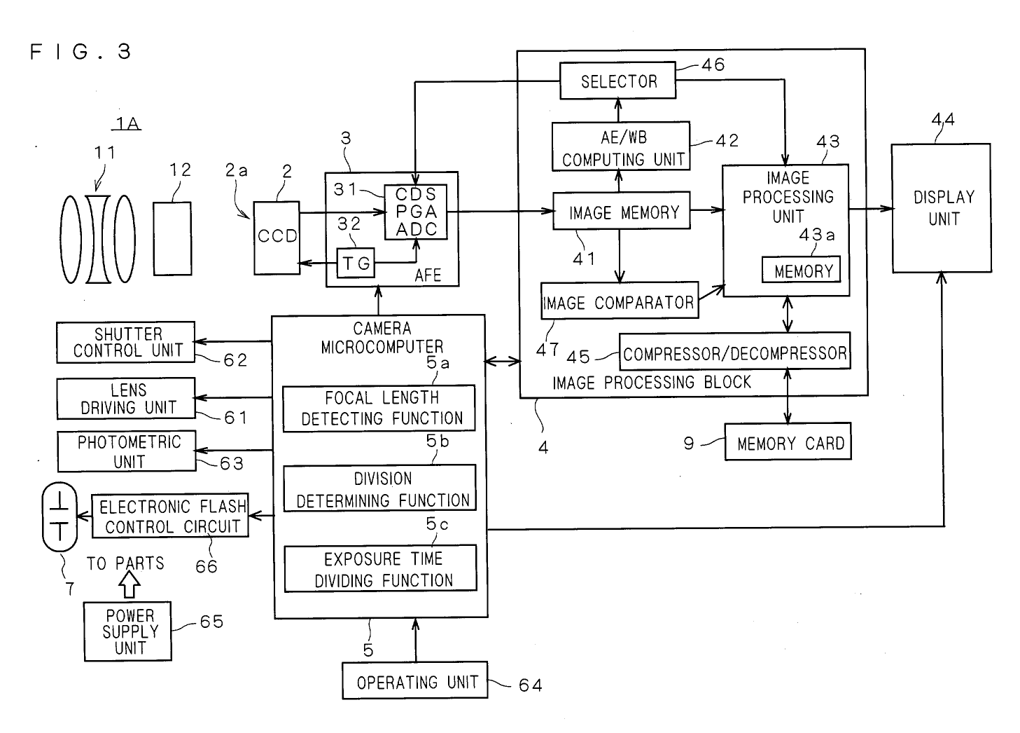

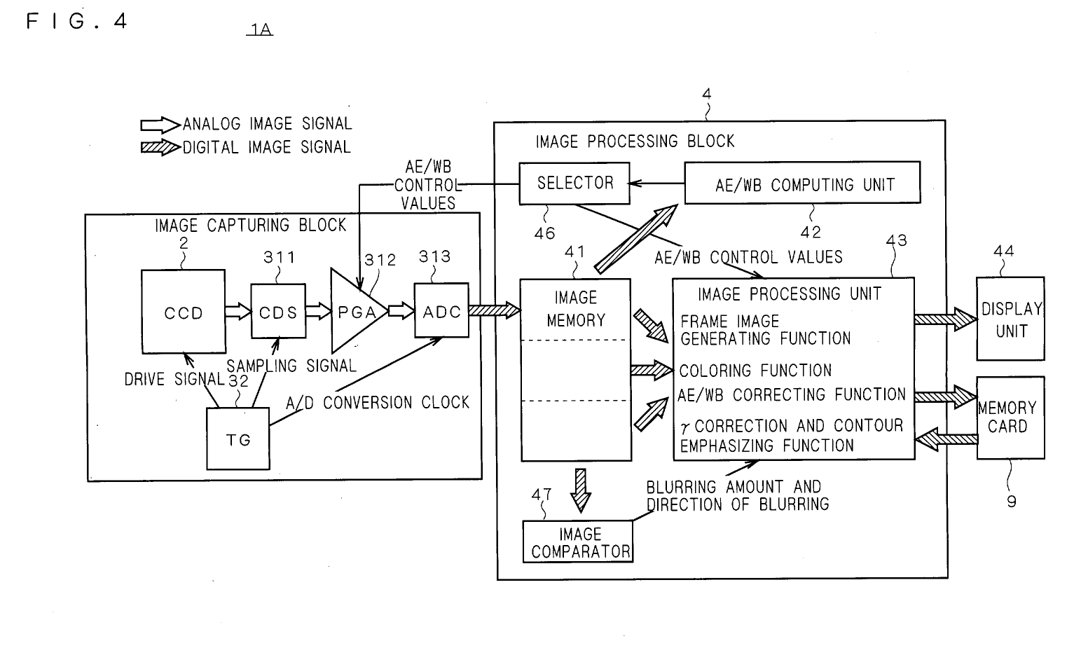

FIG. 3 is a diagram showing functional blocks of the image capturing apparatus 1A. FIG. 4 is a diagram for describing the flow of an image signal and the like in the image capturing apparatus 1A.

The image capturing apparatus 1A has an AFE (Analog Front End) 3 connected to the CCD 2 in a data transmittable manner, an image processing block 4 connected to the AFE 3 in a data transmittable manner, and a camera microcomputer 5 for controlling the components in a centralized manner.

On the surface facing the taking lens 11 of the CCD 2, a light receiving part 2a is provided. In the light receiving part 2a, a plurality of pixels are arranged. The pixel array constructing the light receiving part 2a is divided into three fields, and the CCD 2 can sequentially read charge signals (image signals) accumulated in the pixels from each of the fields at the time of the image capturing operation. The CCD 2 also has a mode of reading signals at high speed (hereinafter, referred to as “high-speed reading mode”). In the high-speed reading mode, in an image capturing standby state before the image capturing operation, an image capturing operation for generating a live view image for preview (hereinafter, referred to as “live-view image capturing”) is carried out.

A method of reading charge signals from the CCD 2 will now be described.

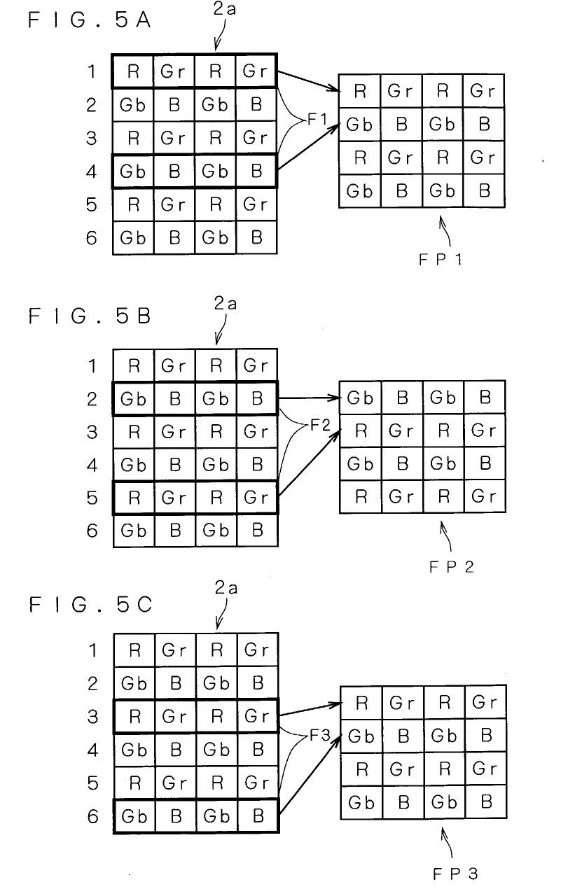

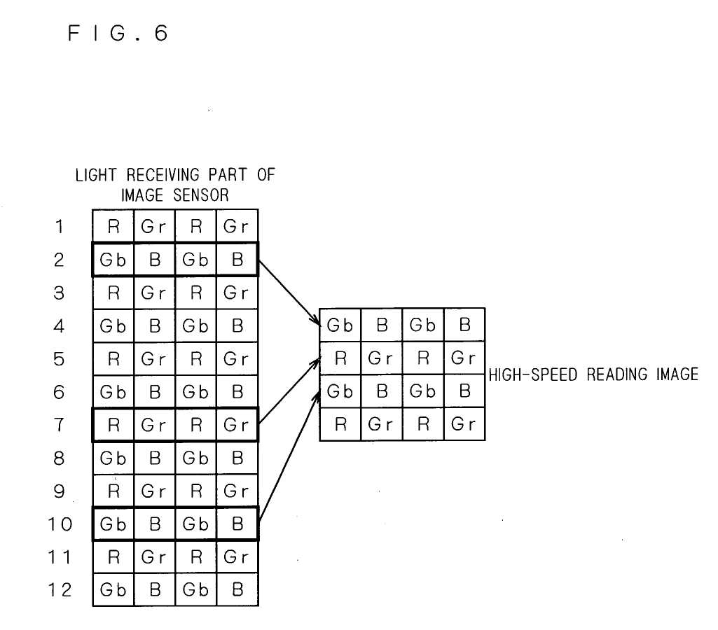

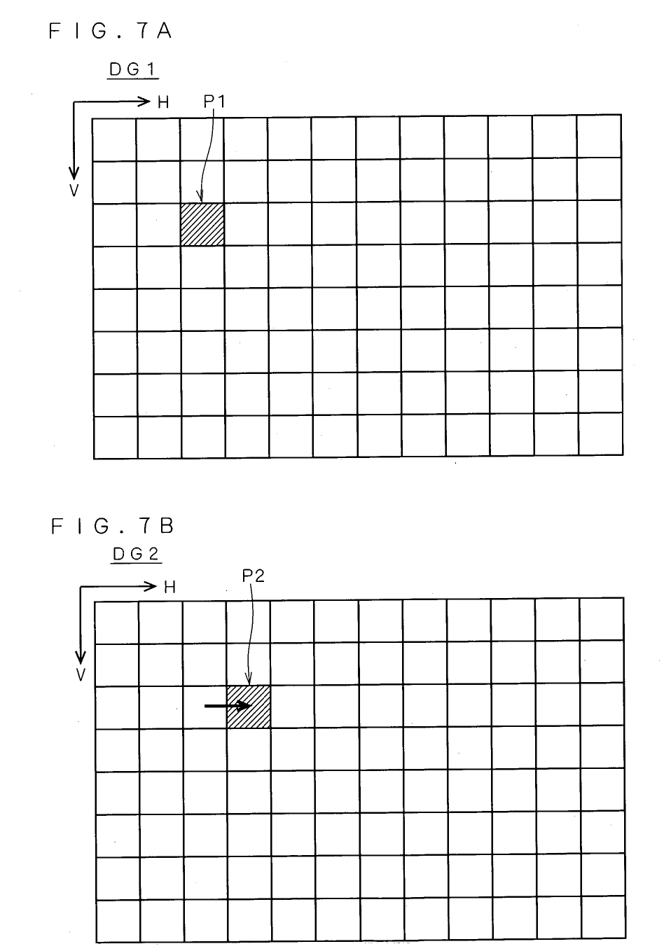

FIGS. 5A to 5C are diagrams for describing the method of reading charge signals of the CCD 2 in the image capturing operation, and FIG. 6 is a diagram for describing the high-speed reading mode of the CCD 2. Although millions of pixels are arranged in the light receiving part 2a of the CCD 2 in reality, in FIGS. 5A to 5C and 6, only a part of the light receiving part 2a is shown for convenience.

As shown in FIGS. 5A to 5C and 6, a color filter array corresponding to the pixel array is provided for the light receiving part 2a. That is, the light receiving part 2a has a color filter array. The color filter array is constructed by color filters of red (R), green (Gr, Gb) and blue (B) which are distributed periodically, that is, three kinds of color filters of different colors.

In the case of reading charge signals accumulated in cells of the CCD 2, as shown in FIG. 5A, lines 1, 4, 7, . . . , that is, the (3n+1)th (n: an integer) lines in the light receiving part 2a are set as a first field F1. Charge signals are read from the first field F1 to construct first field image data FP1. Subsequently, as shown in FIG. 5B, lines 2, 5, 8, . . . , that is, the (3n+2)th lines in the light receiving part 2a are set as a second field F2, and charge signals are read from the second fields F2 to thereby construct second field image data FP2. Finally, as shown in FIG. 5C, lines of 3, 6, 9, . . . , that is, the (3n+3)th lines in the light receiving part 2a are set as a third field F3, and charge signals are read from the third field F3 to thereby obtain third field image data FP3. By such a charge reading method, pixels of all of color components of the color filter array, that is, all of RGB colors are included in each of the first to third fields F1 to F3.

When the “blurring correction mode” is set, the operation of reading charge signals from the first field F1 is performed twice, and two pieces of image data is obtained from the first field F1. In the following, the image data obtained first from the two pieces of image data will be referred to as first divided image data DP1 and the image data obtained later will be referred to as second divided image data DP2. Therefore, exposure time TE (seconds) is divided into almost halves. In the first-half period FH of the exposure time TE (seconds), charge signals accumulated in the light receiving part 2a are read from the first field F1 and construct the first divided image data DP1. Further, in the latter-half period RH of the exposure time TE (seconds), charge signals accumulated in the light receiving part 2a are read from the first field F1 and construct the second divided image data DP2. Setting and division of the exposure time TE (seconds) is performed by an AE/WB computing unit 42 and the camera microcomputer 5.

With respect to the second and third fields F2 and F3, after the first and second divided image data DP1 and DP2 is read from the first field F1, the second and third field image data FP2 and FP3 is sequentially read from each of the fields.

That is, the CCD 2 reads charge signals accumulated in the light receiving part 2a as the first and second divided image data DP1 and DP2 only from the first field F1 from which image data is read first among the first to third fields F1 to F3 at the time of image capturing in each of the first-half period FH and the latter-half period RH of the exposure time TE (seconds).

On the other hand, in the high-speed reading mode, for example, as shown in FIG. 6, charge signals of lines 2, 7, 10, . . . in the light receiving part 2a are read, thereby obtaining image data (hereinafter, referred to as “high-speed reading image data”). That is, data is read in a state where the horizontal lines are reduced to ¼. As shown in FIG. 6, the high-speed reading image data includes data of pixels of all of the RGB colors.

Referring again to FIGS. 3 and 4, the description will be continued.

The AFE 3 is constructed as an LSI (Large Scale Integrated circuit) having a signal processing unit 31 and a TG (Timing Generator) 32 for sending a timing signal to the signal processing unit 31. The TG 32 sends a CCD drive signal to the CCD 2 and a charge signal is outputted from the CCD 2 synchronously with the drive signal.

The signal processing unit 31 has a CDS (Correlated Double Sampler) 311, a PGA (Programmable Gain Amplifier) 312 functioning as an amplifier, and an ADC (A/D Converter) 313. An output signal of each field outputted from the CCD 2 is sampled by the CDS 311 synchronously with a sampling signal from the TG 32 and is subjected to desired amplification by the PGA 312. The amplification factor of the PGA 312 can be changed by numerical data via serial communication from the camera microcomputer 5, and the PGA 312 can correct an image signal in accordance with values (AE control value and WB control value) sent from a selector 46. The analog signal amplified by the PGA 312 is converted into a digital signal by the ADC 313 and the resultant digital signal is sent to the image processing block 4.

The image processing block 4 has an image memory 41, the AE/WB computing unit 42, the image processing unit 43, a compressor/decompressor 45, the selector 46 and an image comparator 47. The AE/WB computing unit 42, image processing unit 43, and image comparator 47 are connected so that data can be transmitted to the image memory 41.

The image memory 41 takes the form of, for example, a semiconductor memory and is a part for temporarily storing the field image data FP1 to FP3 which is converted to digital signals by the ADC 313 and the first and second divided image data DP1 and DP2. After the image data of all of the fields is stored into the image memory 41, the image data is transmitted to the image processing unit 43 in order to generate an image of all of pixels of one frame.

In the case where the “blurring correcting mode” is set, when the first and second divided image data DP1 and DP2 is stored into the image memory 41, the image data DP1 and DP2 is transmitted to the image comparator 47 and the image processing unit 43. After that, in the image processing unit 43 which will be described later, the first and second divided image data DP1 and DP2 is combined, thereby generating the first field image data FP1. The first field image data FP1 is stored into the image memory 41.

The image memory 41 temporarily stores also the high-speed reading image data which is obtained by digitally converting the image data by the ADC 313 and sends the high-speed reading image data to the image processing unit 43 in order to generate a live view image. Further, the high-speed reading image data stored in the image memory 41 is also sent to the AE/WB computing unit 42.

The AE/WB computing unit 42 calculates values (AE control value and WB control value) used to perform automatic exposure (AE) correction and white balance (WB) correction in accordance with the high-speed reading image data sent from the image memory 41.

For example, first, the high-speed reading image data is divided into a plurality of blocks, and multiple division photometric operation of calculating photometric data on a block unit basis is performed to detect the luminance of a subject. As a concrete process of detecting the luminance of a subject, color component values of pixels specified by image data given by R, G or B (luminance values of each color component) are averaged in a whole image and calculated as a subject luminance value so as to correspond to any of the integer values from 0 to 1023. In accordance with the calculated subject luminance value, the AE/WB computing unit 42 sets an aperture value of the taking lens 11 and the exposure time TE seconds (shutter speed) so as to achieve appropriate exposure. In the case where the luminance of the subject is low and the appropriate exposure amount cannot be set, a gain value for adjusting the level of an image signal is set in the PGA 312. Therefore, by the level adjustment on the image signal by the PGA 312, an inappropriate exposure due to insufficient exposure is corrected. That is, the AE/WB computing unit 42 calculates the AE control values such as the aperture value, shutter speed and gain value. Further, the AE/WB computing unit 42 calculates the WB control value so that white balance (WB) of an image to be obtained becomes appropriate in accordance with the calculated luminance value of each color component.

For example, when the calculated subject's luminance is equal to or lower than a predetermined threshold, the AE/WB computing unit 42 determines so as to make the built-in electronic flash 7 emit light, and transmits a signal indicative of the light emission to the camera microcomputer 5.

In the image capturing operation with electronic flash of the built-in electronic flash 7, in a manner similar to a general image capturing apparatus, the built-in electronic flash 7 is allowed to preliminarily emit light before the image capturing operation and an AE control value is calculated. For example, from image data obtained before preliminary light emission, the subject's luminance of image data obtained at the time of making the built-in electronic flash 7 preliminarily emit light, a preliminary light emission amount, and exposure control values (sensitivity, aperture, and shutter speed), an appropriate light emission amount of the built-in electronic flash 7 at the time of the image capturing operation is calculated as an AE control value. The calculated appropriate light emission amount of the built-in electronic flash 7 is sent to an electronic flash control circuit 66 via the camera microcomputer 5 and, on the basis of the control of the electronic flash control circuit 66, a light emission amount of the built-in electronic flash 7 is controlled. As the WB control value, a predetermined WB control value for image capturing with electronic flash is applied under control of the camera microcomputer 5.

The values (AE control value and WB control value) calculated by the AE/WB computing unit 42 are transmitted to the selector 46. The selector 46 transmits the values (AE control value and WB control value) to the signal processing unit 31 or image processing unit 43 in accordance with the situation of reading the high-speed reading image data or the field of the CCD 2.

The image comparator 47 compares the first and second divided image data DP1 and DP2 transmitted from the image memory 41 with each other, thereby detecting a relative blurring amount between the subject and the image capturing apparatus 1A.

The functions of the image comparator 47 will now be concretely described.

First, the image comparator 47 extracts a specific point from each of images DG1 and DG2 based on the first and second divided image data DP1 and DP2 transmitted from the image memory 41. For example, a region of a skin color, a black color, high luminance or the like can be extracted and used as a specific point.

The image comparator 47 compares the positions of the specific points extracted from the images DG1 and DG2, thereby detecting the relative blurring amount between the subject and the image capturing apparatus 1A. As shown in FIG. 5A, the first field F1 is constructed by the (3n+1)th lines (n: an integer) in the light receiving part 2a. Therefore, each of the images DG1 and DG2 is an image whose lines are reduced to ⅓ in the vertical direction.

FIGS. 7A and 7B to 9A and 9B are diagrams illustrating the relation of the positions of the specific points. In each of the images DG1 and DG2, more than one million pixels exist in reality. However, in FIGS. 7A and 7B to 9A and 9B, only pixels of a part of each of the images DG1 and DG2 are shown for convenience, a specific point P1 in the image DG1 and a specific point P2 in the image DG2 are shown and, further, two axes of H and V which perpendicularly cross each other are shown to clarify the positional relation of the pixels.

For example, when the position of the specific point P1 in the image DG1 shown in FIG. 7A and the position of the specific point P2 in the image DG2 shown in FIG. 7B are compared with each other, the specific point is moved only by one pixel in the direction H. The image comparator 47 detects that a blurring of one pixel in the direction H occurs between the subject and the image capturing apparatus 1A after elapse of about TE/2 seconds to the TE seconds since exposure has been started. That is, the image comparator 47 detects that the relative “blurring amount” between the subject and the image capturing apparatus 1A is one pixel in the direction H.

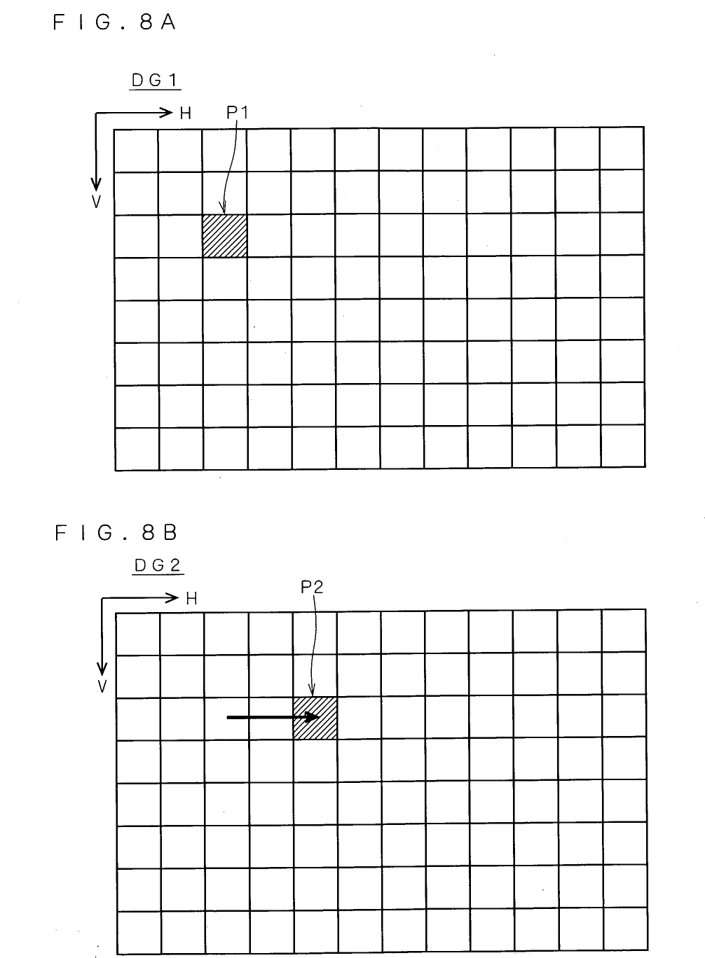

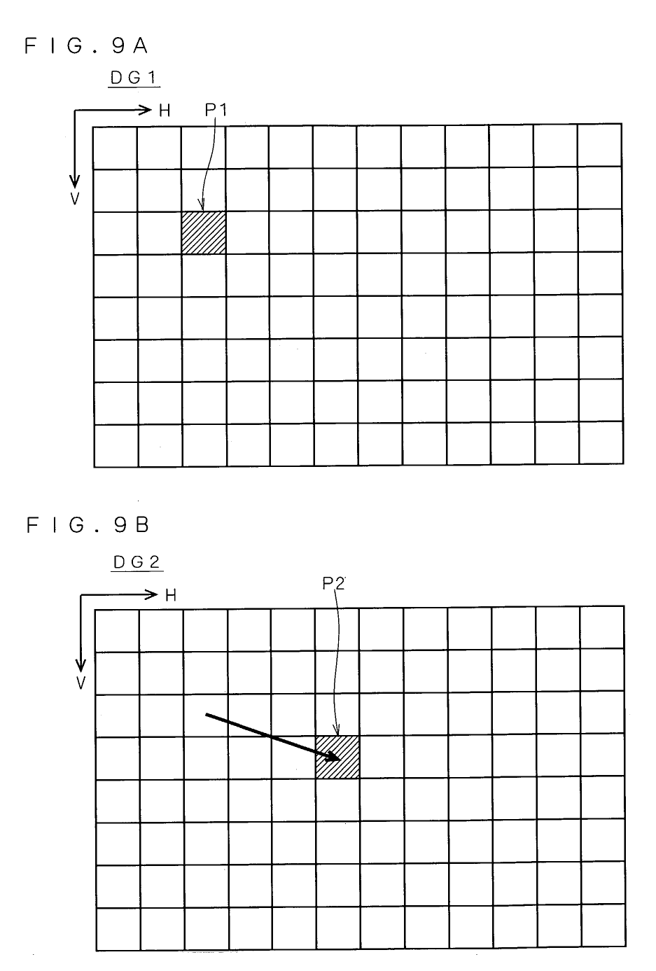

Similarly, with respect to the positional relation between the specific points as shown in FIGS. 8A and 8B, the image comparator 47 detects that the relative blurring amount between the subject and the image capturing apparatus 1A is an amount of two pixels in the direction H. With respect to the positional relation of the specific points as shown in FIGS. 9A and 9B, the image comparator 47 detects that the relative blurring amount between the subject and the image capturing apparatus 1A is an amount of three pixels in the direction H and an amount of one pixel in the direction V (corresponding to three pixels on the CCD 2). That is, the image comparator 47 detects the relative blurring amount between the subject and the image capturing apparatus 1A and the direction of relative blurring which occurs between the subject and the image capturing apparatus 1A.

As described above, the image comparator 47 detects the relative “blurring amount” between the subject and the image capturing apparatus 1A and the “blurring direction” and transmits the “blurring amount” and the “blurring direction” to the image processing unit 43.

The image processing unit 43 performs various image processes on various image data sent from the image memory 41 and has the memory 43a. The memory 43a is a storage medium for temporarily storing image data being subjected to an image process or image data subjected to an image process in the image processing unit 43.

The various functions of the image processing unit 43 will now be described.

For example, the image processing unit 43 combines the first and second divided image data DP1 and DP2 sent from the image memory 41, thereby generating the first field image data FP1. Concretely, by adding the pixel values of the divided image data DP1 and DP2 with respect to each of the pixels, the divided image data DP1 and DP2 is combined.

The image processing unit 43 combines the first to third field image data FP1 to FP3 sent from the image memory 41, thereby generating image data of one frame. Concretely, in each of the first to third field image data FP1 to FP3, image data (pixel values) of the other two fields does not exist. Therefore, by combining the first to third field image data FP1 to FP3, pixel values of pixels which do not exist in the first to third fields F1 to F3 are interpolated and image data of one frame is consequently generated. As a result, a captured image of high quality can be obtained.

The image processing unit 43 colors the image data of one frame generated by combining the first to third field image data FP1 to FP3 and the high-speed reading image data sent from the image memory 41 by performing an interpolating process based on the color filter characteristic of the CCD 2.

The image processing unit 43 also performs various image processes such as y correction for obtaining natural tone and a filter process for performing contour emphasis or saturation adjustment on the colored image data. Further, the image processing unit 43 performs AE and WB correction for adjusting the brightness and color balance of an image in accordance with the values (AE control value and WB control value) sent from the selector 46.

Image data subjected to the AE and WB correction (hereinafter, referred to as “image data for recording and display”) is temporarily stored in the memory 43a and transferred to a display unit 44.

When the “blurring correction mode” is set, the contour emphasizing process as one of image processes performed by the image processing unit 43 is executed in accordance with the “blurring amount” and the “blurring direction” detected by the image comparator 47.

The “blurring” in the captured image caused by the relative “blurring” between the subject and the image capturing apparatus 1A and its correction will be described. A “captured image” in which the “blurring” occurs is an image based on the image data for recording and display.

For example, when the relative “blurring” between the subject and the image capturing apparatus 1A occurs in the horizontal direction, an image in which particularly an edge extending in the vertical direction in the captured image is blurred in the horizontal direction is resulted. When the relative “blurring” between the subject and the image capturing apparatus 1A occurs in the vertical direction, an image in which particularly an edge extending in the horizontal direction in the captured image is blurred in the vertical direction is resulted. Further, when the relative “blurring” between the subject and the image capturing apparatus 1A occurs in an arbitrary direction, an image in which edges extending in the vertical and horizontal directions in the captured image are blurred in the arbitrary direction is resulted. That is, when the relative “blurring” occurs between the subject and the image capturing apparatus 1A, the contour of the subject in the captured image becomes unclear.

Consequently, the image processing unit 43 performs the contour emphasizing process in accordance with the “blurring amount” and the “blurring direction” detected by the image comparator 47 to make the contour of the subject clear, thereby enabling the “blurring” which occurs in the captured image to be corrected.

For example, as shown in FIGS. 7A and 7B, when the “blurring amount” of one pixel is detected in the direction of the H axis (horizontal direction) by the image comparator 47, a relatively weak contour emphasizing process is performed on image data for recording and display so that the edge extending in the direction orthogonal to the H axis direction is emphasized. As shown in FIGS. 8A and 8B, when the “blurring amount” of two pixels is detected in the H axis direction by the image comparator 47, a relatively strong contour emphasizing process is performed on the image data for recording and display so that the edge extending in the direction orthogonal to the H axis direction is emphasized.

When a predetermined “blurring amount” is detected in a predetermined direction, the contour emphasizing process of a predetermined strength according to the “blurring amount” is performed on a captured image so that an edge extending in the direction orthogonal to the predetermined direction is emphasized. Furthermore, when the “blurring amount” larger than the predetermined “blurring amount” is detected in the predetermined direction, the contour emphasizing process stronger than the predetermined strength according to the “blurring amount” is performed on a captured image so that an edge extending in the direction orthogonal to the predetermined direction is emphasized. In other words, the larger the “blurring amount” detected in the predetermined direction is, a stronger contour emphasizing process according to the “blurring amount” is performed on the captured image so that the edge extending in the direction orthogonal to the predetermined direction is emphasized. The contour emphasizing process can be executed by a method similar to general image processing software.

As described above, the image processing unit 43 performs image processes such as the contour emphasizing process on the image data for recording and display in accordance with the “blurring amount” and the “direction of the blurring” detected by the image comparator 47. That is, the image processing unit 43 changes the contents of the contour emphasizing process in accordance with the “blurring amount” and the “direction of the blurring” detected by the image comparator 47. Since the contents of the image process are changed in accordance with the detected “blurring amount” and “direction of the blurring”, an appropriate captured image coped with “conditions of the blurring” such as the “blurring amount” and the “direction of the blurring” can be generated. As a result, the captured image of high quality can be obtained.

As shown in FIGS. 9A and 9B, when the “blurring amount” of three or more pixels is detected in the H axis direction and the “blurring amount” of one or more pixels is detected in the V axis direction by the image comparator 47, only in the case of recording a captured image into the memory card 9, the image processing unit 43 performs the contour emphasizing process on the image data for recording and display in accordance with the “blurring amount” and the “direction of the blurring”.

For example, when the “blurring amount” detected by the image comparator 47 is equal to or larger than a predetermined threshold (three pixels in the H axis direction and one pixel in the V axis direction), a situation occurs such that a plurality of edges cross each other or are close to each other with respect to a subject in a captured image. In such a situation, if the contour emphasizing process for correcting the “blurring” in the captured image is performed, the edges crossing or close to each other exert influences on each other, and an appropriate subject's image matching the actual subject cannot be reproduced in a captured image.

Consequently, when the “blurring amount” detected by the image comparator 47 is equal to or larger than the predetermined threshold (three pixels in the H axis direction and one pixel in the V axis direction), the image processing unit 43 transmits a signal indicative of the fact to the camera microcomputer 5. At this time, the camera microcomputer 5 displays a warning indicating that the “blurring” in the captured image cannot be appropriately corrected (hereinafter, referred to as “blurring occurrence warning indication”) on the LCD 18. The reason why the predetermined threshold in the V axis direction is smaller than that in the H direction is that the images DG1 and DG2 are images corresponding to the first field F1 and are reduced only by ⅓ in the direction V. For the case where a specific point cannot be detected such as a case where the specific point is blurred by an amount less than one pixel in the V axis direction, it is possible to use a region consisting of a few pixels as a specific point and detect the blurring amount in the V axis direction.

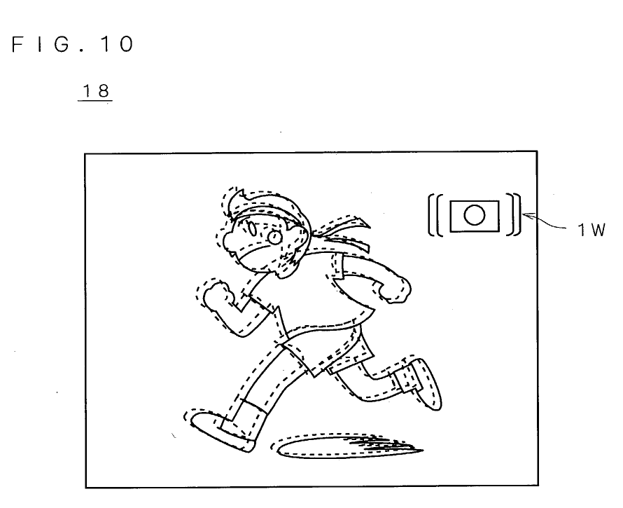

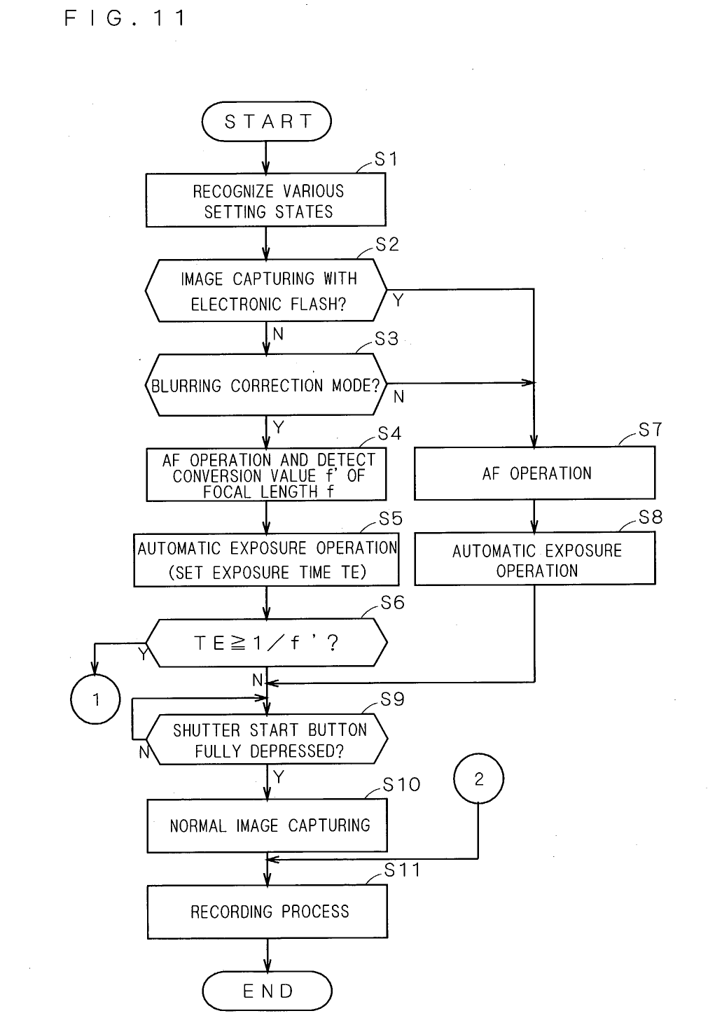

The display unit 44 has the LCD 18 and can display an image based on the image data captured by the CCD 2. The display unit 44 displays the blurring occurrence warning under control of the camera microcomputer 5. That is, when the “blurring amount” equal to or larger than the predetermined amount is detected by the image comparator 47, the blurring occurrence warning is displayed on the LCD 18 to thereby warn the user. FIG. 10 shows an example that a blurring occurrence warning 1W is indicated on the LCD 18. The user sees the blurring occurrence warning 1W indicated on the LCD 18 and promptly knows that a blurring occurs in a captured image.

The compressor/decompressor 45 compresses image data (image data for recording and display) subjected to an image process by the image processing unit 43 in the image capturing operation by, for example, the JPEG method and stores the compressed image data into the memory card 9 as a storage medium. The compressor/decompressor 45 decompresses image data stored in the memory card 9 so as to reproduce and display an image on the display unit 44.

The image capturing apparatus 1A has a lens driving unit 61, a shutter control unit 62, a photometric unit 63, an operating unit 64, a power supply unit 65, the electronic flash control circuit 66 and the built-in electronic flash 7. The lens driving unit 61, shutter control unit 62, photometric unit 63 and electronic flash control circuit 66 are connected so that data can be transmitted to the camera microcomputer 5 and their operation is controlled by the camera microcomputer 5.

The lens driving unit 61 is to change the position of each of lenses provided for the taking lens 11. By the lens driving unit 61, the auto-focus operation and the zooming operation can be executed. The auto-focus operation is controlled by the camera microcomputer 5. For example, in the image capturing standby state, the position of each of the lenses provided for the taking lens 11 is changed so as to achieve focus on the most near side subject (main subject) and the distance to the main subject can be calculated.

The shutter control unit 62 is a part for opening/closing a mechanical shutter 12.

The photometric unit 63 has a photometric sensor and measures the luminance of a subject. Alternately, the luminance of a subject may be calculated from an output of the CCD 2.

The electronic flash control circuit 66 is a part for controlling the light emission of the built-in electronic flash 7.

The operating unit 64 is constructed by various operating members such as the shutter start button 14, mode switching button 15 and operating buttons 19, and transmits an electric signal to the camera microcomputer 5 in accordance with operation of the various operating members by the user.

As described above, in the case where the “blurring correction mode” is set, when the blurring amount detected by the image comparator 47 is equal to or larger than the predetermined threshold, the blurring occurrence warning 1W is indicated on the LCD 18. Consequently, the user sees the blurring occurrence warning 1W and variously operates the operation buttons 19, thereby enabling whether a captured image (image data for recording and display) is stored into the memory card 9 or not to be selected. If the user selects that the captured image is not stored into the memory card 9, the image data for recording and display temporarily stored in the memory 43a of the image processing unit 43 is erased and compression by the compressor/decompressor 45 and the process of storing the image into the memory card 9 are not performed. That is, the operation buttons 19 function as means for selecting whether image data (image data for recording and display) generated in accordance with the first and second divided image data DP1 and DP2 is stored or not in accordance with the operation of the user after the blurring occurrence warning 1W is displayed on the LCD 18.

Therefore, when the relative “blurring amount” between the subject and the image capturing apparatus 1A is large to a certain extent, the warning is indicated. The user can be notified with reliability of the situation that “blurring” might occur in a captured image, so that it can contribute to decision of the user after that. Further, the user can grasp occurrence of the “blurring” in a captured image to a certain degree and select whether the captured image is recorded or not. As a result, by omitting a process such as the process of recording the captured image, the processing speed is increased, power consumption is reduced, and the capacity of the recording medium such as the memory card 9 can be effectively used.

The power supply unit 65 has a battery for supplying power to the components of the image capturing apparatus 1A.

The camera microcomputer 5 has a CPU, a memory and a ROM and is a part for controlling parts of the image capturing apparatus 1A in a centralized manner. The function of the camera microcomputer 5 is realized by executing a program stored in the ROM.

The camera microcomputer 5 has, as its functions, a focal length detecting function 5a, a division determining function 5b and an exposure time dividing function 5c.

The focal length detecting function 5a is a function of detecting and converting a focal length f of the taking lens 11 into a focal length f′ in the case of a 35 mm film. When a not-shown zoom button is operated to change the focal length of the lens, the focal length detecting function 5a calculates the focal length f of the taking lens 11 after the zooming operation from the lens position. The focal length detecting function 5a converts the focal length f into the focal length f′ in the case of a 35 mm film, and detects the focal length f′.

The division determining function 5b determines whether the exposure time TE (seconds) is divided by the exposure time dividing function 5c or not in accordance with the exposure time TE (seconds) calculated by the AE/WB computing unit 42 and the focal length f′ calculated by the focal length detecting function 5a. For example, when the relation of exposure time TE (seconds)≧1/f′ is satisfied, the division determining function 5b determines that the exposure time TE (seconds) is divided by the exposure time dividing function 5c. When the relation of the exposure time TE (seconds)≧1/f′ is satisfied, generally, the possibility that “movement of camera” or the like occurs is relatively high. Consequently, when the exposure time TE (seconds) is longer than the predetermined time 1/f′ based on the focal length f′ of the taking lens 11, the exposure time TE is divided and the blurring amount is detected. As a result, the case where there is the possibility of occurrence of blurring and the case where the possibility of occurrence of blurring is extremely low can be appropriately and easily determined.

The exposure time dividing function 5c divides the exposure time TE (seconds) calculated by the AE/WB computing unit 42 into halves in accordance with the result of determination of the division determining function 5b. To be specific, when the exposure time TE (seconds) calculated by the AE/WB computing unit 42 is longer than the predetermined time (1/f′) based on the focal length of the taking lens 11, the exposure time dividing function 5c divides the exposure time TE (seconds) into two periods. The exposure time dividing function 5c controls the driving of the TG 32 on the basis of the exposure time TE/2 (seconds) obtained by dividing the exposure time TE into halves.

On the other hand, when the relation of the exposure time TE (seconds)≧1/f′ is not satisfied, the exposure time dividing function 5c is controlled so as not to divide the exposure time TE (seconds) into two periods (a plurality of periods). As a result, by omitting a useless process in the case where the possibility that a “blurring” occurs is very low, the image capturing process is performed promptly and power consumption can be reduced.

In the image capturing apparatus 1A, at the time of image capturing operation with electronic flash of the built-in electronic flash 7, the exposure time with electronic flash does not become longer than the predetermined time (1/f′). Therefore, in the case of the image capturing operation with electronic flash, it is controlled so that the detection of the focal length f′ in the focal length detecting function 5a and the determination in the division determining function 5b are not performed. As a result, the exposure time dividing function 5c is controlled so as not to divide the exposure time in the image capturing operation with electronic flash into a plurality of periods.

Therefore, in the case of performing the image capturing operation with electronic flash, the relative “blurring amount” between the subject and the image capturing apparatus is not detected. That is, by omitting the useless process in the case where the possibility that the “blurring” occurs is extremely low, the image capturing process can be performed promptly and the power consumption can be reduced. When the exposure time is divided into a plurality of periods during the image capturing operation with electronic flash, electronic flash is emitted only in a part of the plurality of periods obtained by dividing the exposure time TE (seconds). Therefore, a large luminance difference occurs between the first and second divided image data DP1 and DP2 to be compared with each other, so that the image data DP1 and DP2 cannot be compared accurately with each other and erroneous operation is caused. In this case, the erroneous operation can be also prevented.

In the case where the relation of the exposure time TE (seconds)≧1/f′ is not satisfied or the case of the image capturing operation with electronic flash, after completion of exposure, image capturing of a type of reading charge signals from each of the first to third fields F1, F2 and F3 of the CCD 2 (hereinafter, referred to as “normal image capturing operation”) is performed.

The camera microcomputer 5 stores various setting conditions into a memory or a ROM so as to be managed.

3. Image Capturing Operation

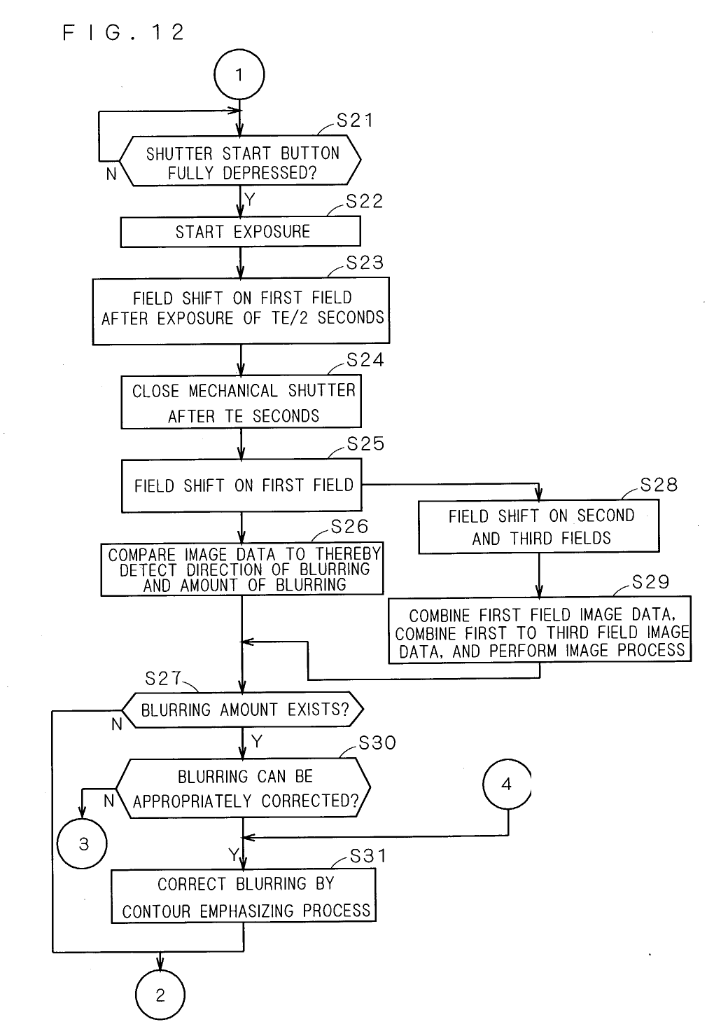

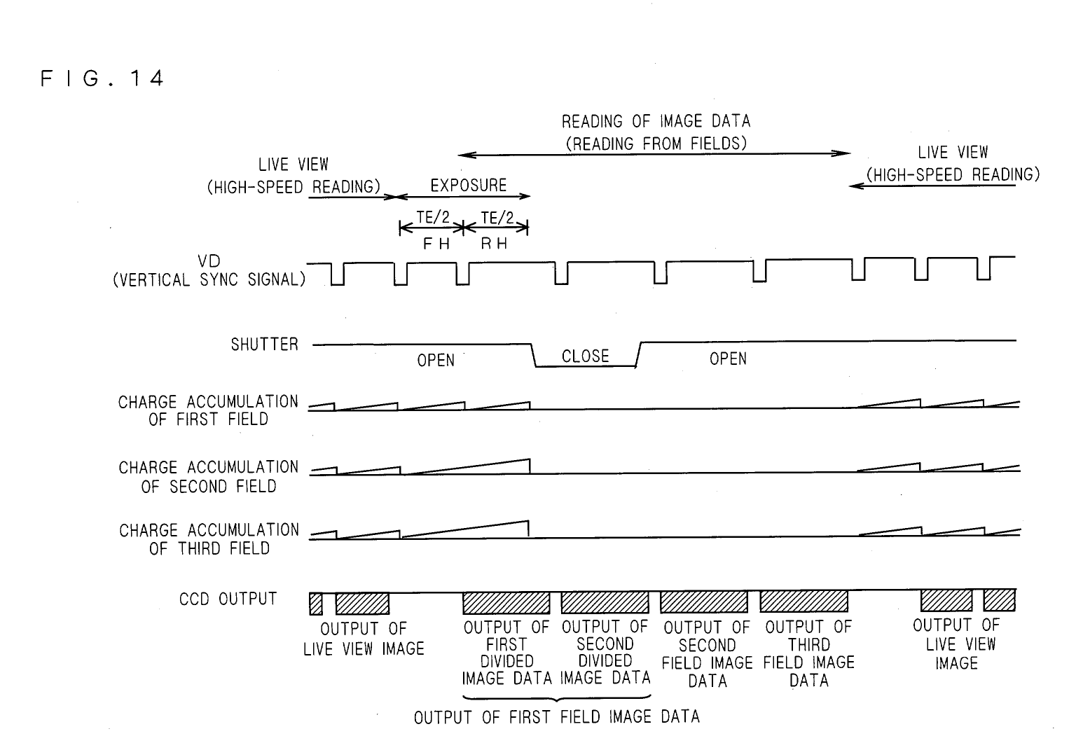

FIGS. 11 to 13 are flowcharts for describing a basic image capturing operation of the image capturing apparatus 1A. The operation is executed by the control of the camera microcomputer 5. FIG. 14 is a diagram for describing the image capturing operation of the image capturing apparatus 1A in which the “blurring correction mode” is set and is a timing chart showing a vertical sync signal VD, the mechanical shutter 12, charge storage states of the first to third fields F1 to F3 in the CCD 2, and an output of the CCD 2. In the following, the flowcharts of FIGS. 11 to 13 will be described with reference to FIG. 14.

First, when the user touches the shutter start button 14 to set the state S1 in the image capturing standby mode, the image capturing operation is started, and the program advances to step S1.

In step S1, the camera microcomputer 5 recognizes various setting states and the program advances to step S2. In step S1, the various setting states such as the “blurring correction mode” and “the use/unuse of the built-in electronic flash 7” are recognized.

In step S2, whether or not the image capturing operation is the image capturing operation with electronic flash for capturing a picture with flashlight of the built-in electronic flash 7 is determined. In step S2, in accordance with “the use/unuse of the built-in electronic flash 7” recognized in step SI and the luminance of the subject, whether the image capturing operation is the image capturing operation with electronic flash or not is determined. If NO, the program advances to step S3. If YES, the program advances to step S7.

In step S3, whether the “blurring correction mode” is set or not is determined. If YES, the program advances to step S4. If NO, the program advances to step S7.

In step S4, the auto-focus operation is performed and the focal length f of the taking lens 11 is converted in the focal length f′ in the case of the 35 mm film. After that, the focal length f′ is detected and the program advances to step S5.

In step S5, the automatic exposure operation is performed and the exposure time (shutter speed) TE (seconds) is set. The program advances to step S6.

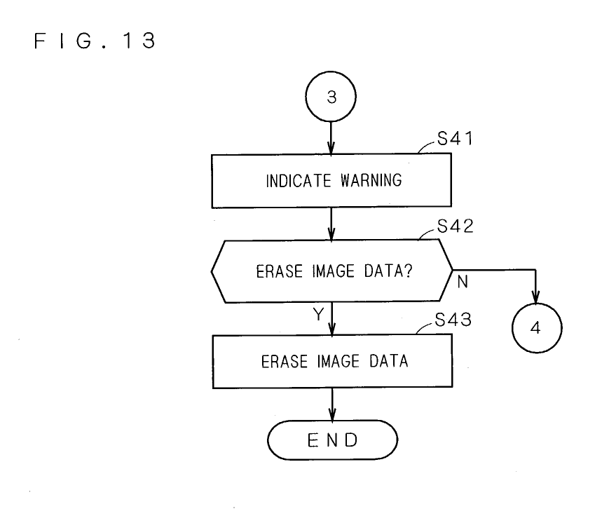

In step S6, whether the relation of TE≧1/f between the focal length f′ detected in step S4 and the exposure time TE (seconds) which is set in step S5 is satisfied or not is determined. If YES, the program advances to step S21 in FIG. 12. If NO, the program advances to step S9.

The case where the program advances from step S2 to step S7 will now be described.

In step S7, the auto-focus operation is performed. After that, the program advances to step S8.

In step S8, the automatic exposure operation is performed and, after that, the program advances to step S9.

In step S9, in any of the case where the program advanced from step S6 or S8, whether the shutter start button 14 is fully depressed or not is determined. If YES, the program advances to step S10. If NO, the program repeats the determination of step S9.

In step S10, after completion of the exposure, the normal image capturing operation of the type of reading the charge signals from each of the first to third fields F1, F2 and F3 of the CCD 2 is performed. Image data for recording and display is obtained by combining the first to third field image data FP1 to FP3 and various image processes are performed on the resultant data. After that, image data subjected to the various image processes is temporarily stored into the memory 43a and the program advances to step S11.

In step S11, the image data for recording and display stored in the memory 43a in step S10 is compressed by the compressor/decompressor 45 and the compressed image data is stored into the memory card 9. After that, the image capturing operation is finished and the image capturing standby state is set again.

In step S21, whether the shutter start button 14 is fully depressed or not is determined. If YES, the program advances to step S22. If NO, the program repeats the determining operation of step S21.

In step S22, exposure of the image capturing operation is started. The program advances to step S23.

In step S23, after TE/2 seconds since the start of exposure, an operation of shifting the charge signal accumulated in the light receiving part 2a to the vertical transfer CCD (field shift) is performed with respect to the first field F1, thereby reading the first divided image data DP1. After that, the program advances to step S24.

In step S24, after TE seconds since the start of exposure, the mechanical shutter 12 is closed, thereby finishing the exposure. After that, the program advances to step S25.

In step S25, an operation of shifting the charge signal accumulated in the light receiving part 2a in the latter-half period RH of the exposure time TE (seconds) to the vertical transfer CCD (field shift) is performed with respect to the first field F1, thereby reading the second divided image data DP2. After that, the program advances to steps S26 and S28.

The process in step S26 and the processes in steps S28 and S29 are performed in parallel.

First, the process in step S26 will be described.

In step S26, the image comparator 47 compares the first divided image data DP1 read in step S23 with the second divided image data DP2 read in step S25 and detects the relative “blurring direction” and the “blurring amount” between the subject and the image capturing apparatus 1A.

In step S27, in accordance with the “blurring amount” detected in step S26, the image comparator 47 determines whether there is the “blurring amount” or not. If YES, the program advances to step S30. If NO, the program advances to step S11 in FIG. 11.

The processes in steps S28 and S29 will now be described.

In step S28, an operation of sequentially shifting the charge signals accumulated in the light receiving part 2a (field shift) is performed with respect to the second and third fields F2 and F3, thereby reading the second and third field image data FP2 and FP3. After that, the program advances to step S29.

In step S29, the image processing unit 43 combines the first and second divided image data DP1 and DP2 read in steps S23 and S25 to thereby generate the first field image data FP1, after that, combines the first to third field image data FP1 to FP3, and performs various image processes, thereby generating the image data for recording and display. The image data for recording and display is temporarily stored into the memory 43a. The program advances to step S27.

In step S30, in accordance with the “blurring amount” detected in step S26, whether the “blurring” can be appropriately corrected or not is determined. When the “blurring amount” is smaller than a predetermined threshold (three pixels in the H axis direction and one pixel in the V axis direction), it is determined that the blurring can be appropriately corrected and the program advances to step S31. On the other hand, when the “blurring amount” is equal to or larger than the predetermined threshold (three pixels in the H axis direction and one pixel in the V axis direction), it is determined that the blurring cannot be appropriately corrected and the program advances to step S41 in FIG. 13.

In step S31, the image processing unit 43 performs a contour emphasizing process according to the “direction of the blurring” and the “blurring amount” detected in step S26 on the image data for recording and display, thereby correcting the blurring. After that, the program advances to step S11 in FIG. 11.

The case where the program advances from step S30 to step S41 in FIG. 13 will now be described.

In step S41, the blurring occurrence warning 1W indicative of the state where the “blurring” on the image data for recording and display cannot be appropriately corrected is indicated on the LCD 18. After that, the program advances to step S42.

In step S42, whether the image data for recording and display which is temporarily stored in the memory 43a is erased or not is determined. When the user variously operates the operation buttons 19 to select the erasure of the image data, it is determined that the image data for recording and display is erased and the program advances to step S43. When the user does not select erasure of the image data by variously operating the operation buttons 19, it is determined that the image data for recording and display is not erased and the program advances to step S31 in FIG. 12.

In step S43, the image data for recording and display temporarily stored in the memory 43a is erased, the image capturing operation is finished, and the image capturing standby state is obtained again.

As described above, in the image capturing apparatus 1A according to the embodiment, the CCD 2 is used in which the charge signals accumulated in the light receiving part 2a can be sequentially read from each of the first to third fields F1 to F3 (a plurality of fields) of the pixel array of the light receiving part 2a. In the image capturing operation, with respect to the first field F1, the charge signals accumulated in each of the periods obtained by dividing the exposure time TE (seconds) into halves are read as the first and second divided image data DP1 and DP2. By comparing the read two pieces DP1 and DP2 of image data with each other, the states of the blurring such as the relative blurring amount and direction of the blurring between the subject and the image capturing apparatus 1A are detected. As a result, it is possible to provide an image capturing apparatus which can deal with the blurring which occurs in the image capturing operation even with exposure of short time without enlarging the apparatus.

In the image capturing operation, only with respect to the first field F1, the charge signals accumulated in the two or more periods (for example, two periods FH and RH) obtained by dividing the exposure time TE (seconds) into a plurality of periods are read as image data. As a result, by omission of a useless process, detection of the “blurring amount” in short time and the like, the process can be performed promptly.

(4) Modifications

Although the embodiments of the present invention have been described above, the present invention is not limited to the above.

For example, in the above-described embodiments, the predetermined thresholds for the “blurring amount” used at the time of determining whether the “blurring” can be appropriately corrected or not are the amount of three pixels in the H axis direction and the amount of one pixel in the V axis direction. However, the present invention is not limited to the thresholds. For example, the predetermined thresholds may be variously changed as “an amount of six pixels in the H axis direction and an amount of two pixels in the V axis direction”.

In the above-described embodiments, when the user does not select erasure of image data by variously operating the operation buttons 19 even in the case where the “blurring amount” is equal to or larger than the predetermined thresholds (the amount of three pixels in the H axis direction and the amount of one pixel in the V axis direction), the contour emphasis according to the “blurring amount” and the “direction of the blurring” is performed on the image data for recording and display. However, when the “blurring amount” is equal to or larger than the predetermined thresholds (the amount of three pixels in the H axis direction and the amount of one pixel in the V axis direction), the contour emphasis according to the “blurring amount” and the “direction of the blurring” may not be performed. With such a configuration, in the case of using an image capturing technique such as so-called “panning” of capturing an image while moving a camera in accordance with the speed of a moving body and the travel direction, an image such that a moving subject is fixed in the center and the background moves can be obtained. That is, an effect of emphasizing the flow of the subject and the speed of movement can be produced in a captured image.

In the above-described embodiments, the exposure time TE (seconds) is divided into almost halves and charge signals accumulated in the first field F1 are read twice, but the present invention is not limited to the method. For example, by dividing the exposure time into three periods, reading the charge signals accumulated in the first field in three times, and comparing at least two pieces of image data out of three pieces of image data, the relative “blurring amount” and “direction of the blurring” between the subject and the image capturing apparatus may be detected.

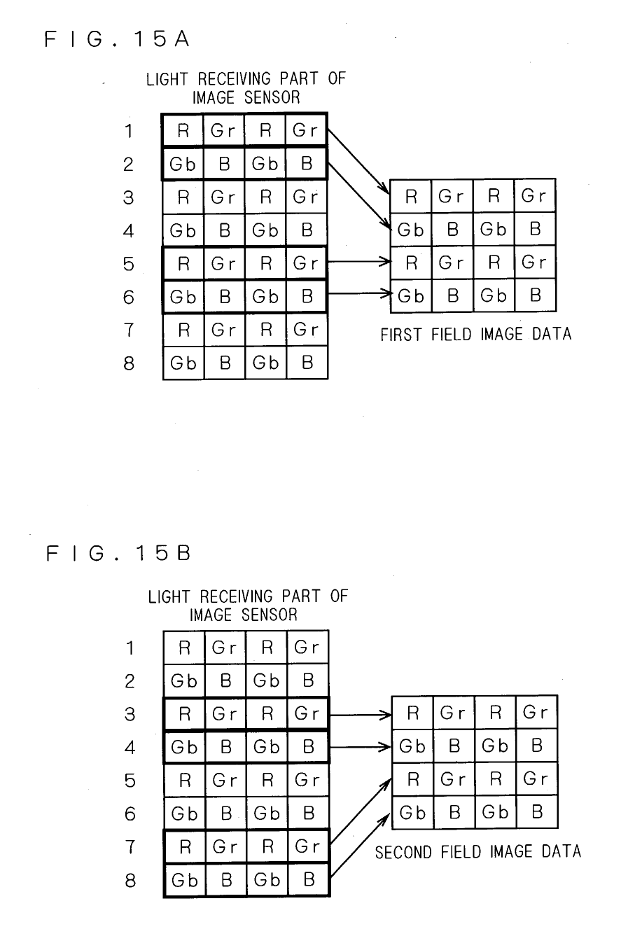

In the above-described embodiments, on the precondition that a color image is obtained, the pixels corresponding to all of color components of the color filter array are included in each of the fields F1 to F3 of the light receiving part 2a. It is also possible to use the light receiving part 2a which is divided into two fields each including pixels corresponding to all of color components of the color filter array. For example, as shown in FIGS. 15A and 15B, lines 1, 2, 5, 6, . . . in the light receiving part, that is, the (4n+1)th lines and (4n+2) lines (n: an integer) may be set as a first field and lines 3, 4, 7, 8, . . . in the light receiving part, that is, the (4n+3)th lines and the (4n+4)th lines (n: an integer) may be used for a second field.

In the above-described embodiments, on the precondition that a color image is obtained, the CCD 2 has the color filter array. The present invention, however, is not limited to the configuration. A so-called “CCD for a monochrome image” having no color filter array may be used. In the case of using such a CCD for a monochrome image, it is sufficient to extract a high-luminance part or the like as the specific point by the image comparator 47. Further, in the case of using such a CCD for a monochrome image, it is also possible to divide the light receiving part into two or more fields and sequentially read charge signals accumulated.

Although the exposure time TE (seconds) is divided into two periods when the exposure time TE (seconds) is equal to or longer than predetermined time (1/f′) based on the focal length of the taking lens 11 in the above-described embodiments, the present invention is not limited to the configuration. In consideration of allowance for the exposure time in which the possibility of occurrence of the relative “blurring” between the subject and the image capturing apparatus is high, when the exposure time TE (seconds) is equal to or longer than the predetermined time 1/(2f′) based on the focal length of the taking lens 11, the exposure time TE (seconds) may be divided into two periods.

In the above-described embodiment, when the “blurring amount” detected in the image comparator 47 is equal to or larger than the predetermined amount, the user variously operates the operation buttons 19 so that the image data for recording and display is not recorded into the memory card 9. However, the present invention is not limited to the arrangement but the captured image data may not be automatically recorded into the memory card 9 when the “blurring amount” is equal to or larger than the predetermined amount. In other words, when the “blurring amount” of the predetermined amount or larger is detected by the image comparator 47, the image data for recording and display generated in accordance with the first and second divided image data DP1 and DP2 is not recorded into the memory card 9. Therefore, when a blurring of a certain degree occurs in a captured image, the image data is not recorded. As a result, by omitting the useless process, the process is performed promptly, power consumption is reduced, and the capacity of the memory card 9 or the like can be effectively used.

Although the contour emphasizing process is performed to correct the “blurring” in a captured image in the image processing unit 43 in the above-described embodiments, the present invention is not limited to the method. When the blurring amount which is equal to or larger than the predetermined amount is detected in the image comparator 47, it is sufficient to display the blurring occurrence warning on the LCD 18 and to allow the user or the image capturing apparatus to select whether the captured image is recorded into the memory card 9 or not.

Although only the contour emphasizing process for correcting a captured image is performed in accordance with the “blurring amount” in the H axis direction (horizontal direction) in the above-described embodiments, it is also possible to perform a contour emphasizing process for correcting the captured image in accordance with the “blurring amount” in the V axis direction (vertical direction).

Although the specific points are extracted from the two images DG1 and DG2 and a movement amount is detected as a relative “blurring amount” between the subject and the image capturing apparatus 1A by the image comparator 47. The present invention is not limited to the method. The “blurring amount” may be detected by other methods such as a method of extracting a region in a center portion from each of the two images DG1 and DG2 and detecting correlation between the image data.

Although the exposure time TE is set by the AE/WB computing unit 42 in the above-described embodiment, the present invention is not limited to the above. The exposure time TE of the CCD 2 may be set by variously operating the operation buttons 19 by the user.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image sensor capable of sequentially reading, as image data, charge signals accumulated in a light receiving part from each of a plurality of fields of the light receiving part;
a setting unit for setting exposure time of said image sensor;
a divider for dividing the exposure time which is set by said setting unit into a plurality of periods;
a reader for reading the charge signals accumulated in said light receiving part as first and second image data from a first field in said plurality of fields in each of two periods out of said plurality of periods;
a comparator for comparing the first and second image data read by said reader; and
a controller for controlling an operation of the image capturing apparatus in accordance with a result of the comparison by said comparator.

2. The image capturing apparatus according to claim 1, further comprising:
a detector for detecting a state of a blurring which occurs between a subject and the image capturing apparatus in accordance with the result of comparison by said comparator.

3. The image capturing apparatus according to claim 2, wherein
said detector detects an amount of the blurring which occurs between the subject and the image capturing apparatus, and
said controller gives a warning when the amount of the blurring which is equal to or larger than a predetermined amount is detected by said detector.

4. The image capturing apparatus according to claim 3, further comprising:
a selector for selecting whether image data generated in accordance with said first and second image data is recorded or not after said warning.

5. The image capturing apparatus according to claim 2, further comprising:
an image processor for processing image data read by said image sensor, wherein
said controller changes an image process performed by said image processor in accordance with the state of the blurring detected by said detector.

6. The image capturing apparatus according to claim 5, wherein
said image process is contour emphasis.

7. The image capturing apparatus according to claim 5, wherein
said detector detects an amount of the blurring which occurs between the subject and the image capturing apparatus, and
said controller changes an image process performed by said image processor in accordance with the amount of the blurring detected by said detector.

8. The image capturing apparatus according to claim 5, wherein
said detector detects a direction of the blurring which occurs between the subject and the image capturing apparatus, and
said controller changes an image process performed by said image processor in accordance with the direction of the blurring detected by said detector.

9. The image capturing apparatus according to claim 2, wherein
said detector detects an amount of the blurring which occurs between the subject and the image capturing apparatus, and
when the amount of the blurring which is equal to or larger than a predetermined amount is detected by said detector, said controller inhibits recording of image data generated in accordance with said first and second image data.

10. The image capturing apparatus according to claim 1, wherein
when the exposure time set by said setting unit is longer than predetermined time, said divider divides the exposure time set by said setting unit into the plurality of periods.

11. The image capturing apparatus according to claim 10, wherein
said predetermined time is time based on a focal length of a taking lens.

12. The image capturing apparatus according to claim 1, further comprising:
an electronic flash device for illuminating a subject with flashlight, wherein
said divider does not divide the exposure time set by said setting unit into a plurality of periods at the time of image capturing with flashlight emitted by the flash device.

13. The image capturing apparatus according to claim 1, further comprising:
an image generator for generating a piece of image data by combining image data read from said plurality of fields in said image sensor.

14. The image capturing apparatus according to claim 1, wherein
said reader reads charge signals accumulated in said light receiving part in each of two periods out of said plurality of periods only from said first field.

15. The image capturing apparatus according to claim 1, further comprising:
a light shielding member for shielding said image sensor after elapse of the exposure time set by said setting unit since start of an exposure of said light receiving part with light, wherein
said reader reads charge signals accumulated in said light receiving part as second image data after shielding by said light shielding member.
